(19) United States
(12) Patent Application Publication
(10) Pub. No.: US 2005/0055375 A1
(43) Pub. Date: Mar. 10, 2005

(54) Recording and reproducing system, recording apparatus, reproducing apparatus, record medium, recording and reproducing method, recording method, reproducing method, program and record medium

(76) Inventors: Yasuyuki Torii, Kyoto (JP); Toshihiko Mizukami, Osaka (JP); Kevin Leigh La Chapelle, Redmond, WA (US); Ian Cameron Mercer, Sammammish, WA (US)

Correspondence Address: SMITH GAMBRELL & RUSSELL LLP, Suite 800, 1850 M Street N W, Washington, DC, 20036, US

(21) Appl. No.: 10/725,940

(22) Filed: Dec. 3, 2003

Related U.S. Application Data
(60) Provisional application No. 60/433,009, filed on Dec. 13, 2002.

(51) Int. Cl. G06F 7/00

(52) U.S. Cl. 707/104.1

(57) ABSTRACT

[Problem] There has been a problem that, in the case where a plurality of play list files are recorded in a record medium such as a CD-R, it is difficult to manage the play list files.

[Means for Solution] A recording and reproducing system has a CD-RW medium 15 for holding a plurality of play list files for storing a play list describing reproduction order of a plurality of data files, a file recording means 14 of storing in a play list file menu file a play list file menu which is information for selecting a predetermined play list file, a menu definition file creating means 33, a controlling means 21 of displaying play list file menu information on all or a part of the stored play list file menus and selecting the predetermined play list file according to an instruction, a reproduction instructing means 22, a file reproducing means 23, and a data file output means 24.

### FIELD OF THE INVENTION

The present invention relates to a recording and reproducing system, a recording apparatus, a reproducing apparatus, a record medium, a recording and reproducing method, a recording method, are producing method, a program and a record medium.

### PRIOR ART

To begin with, a description will be given as to configuration and operation of a personal computer (refer to the patent document 1, Japanese Patent Laid-Open No. 2000-235780, for instance) for reproducing data files such as a video file having video data and an audio file having audio data.

The data files such as the video file and audio file are recorded on a record medium such as a CD-R (Compact Disk-Recordable) according to a predetermined file system.

The personal computer performed play list reproduction wherein a play list file in an HTML (Hypertext Markup Language) format describing reproduction order of the data files by using file names of the data files is interpreted to consecutively reproduce a plurality of data files.

However, the inventor of the present invention noticed that, in the case where a plurality of play list files are recorded in a record medium such as a CD-R, it is difficult to manage the play list files.

Moreover, the inventor of the present invention implemented an invention, for the sake of managing the plurality of play list files, of constructing a hierarchical structure for the purpose of creating a directory for storing the play list files and classifying the play list files, and also reviewed the invention. Consequently, the inventor of the present invention noticed that, as considerable time is required for an analysis of the directory performed when reproducing the data file in such an invention, device usability for a user is not good enough.

### MEANS TO SOLVE THE PROBLEMS

In consideration of the above problem in the past, an object of the present invention is to provide a recording and reproducing system, a recording apparatus, a reproducing apparatus, a record medium, a recording and reproducing method, a program and a record medium capable of, even in the case where a plurality of play list files are stored in a record medium such as a CD-R, efficiently managing the play list files.

The 1^{st} aspect of the present invention is a recording and reproducing system comprising:
a record medium (15) holding a plurality of data files (13) of storing predetermined data and also holding a plurality of play list files (17) of storing a play list describing reproduction order of said plurality of data files (13);
play list file menu storing means (14, 33) of storing a play list file menu which is information of selecting a predetermined play list file (17) of said plurality of play list files (17) in a play list file menu file (16) held on said record medium (15);
play list file menu display means (21, 23, 24) of displaying to the outside play list file menu information on all or a part of said stored play list file menu;
play list file selecting means (21, 22, 23, 24) of selecting said predetermined play list file (17) according to an instruction from the outside; and
data reproducing means (21, 23, 24) of reproducing the predetermined data stored by said plurality of data files (13) respectively by using said reproduction order based on said selected play list file (17).

The 2^{nd} aspect of the present invention is the recording and reproducing system according to the 1^{st} aspect of the present invention, wherein said play list file menu display means (21, 23, 24) displays said play list file menu information in consideration of a type of said predetermined data reproducible by said data reproducing means (21, 23, 24).

The 3^{rd} aspect of the present invention is the recording and reproducing system according to the 1^{st} aspect of the present invention, wherein said play list file menu display means (21, 23, 24) displays said play list file menu information by using a thumbnail image changing according to a state in which said play list file selecting means (21, 22, 23, 24) selects said predetermined play list file (17).

The 4^{th} aspect of the present invention is the recording and reproducing system according to the 1^{st} aspect of the present invention, wherein said play list file menu display means (21, 23, 24) displays said play list file menu information by using predetermined text data on all or a part of said play list.

The 5^{th} aspect of the present invention is a recording apparatus comprising play list file menu storing means of storing a play list file menu which is information of selecting a predetermined play list file of a plurality of play list files of storing a play list describing reproduction order of a plurality of data files of storing predetermined data in a play list file menu file held by a record medium holding said plurality of data files and also holding said plurality of play list files.

The 6^{th} aspect of the present invention is the recording apparatus according to the 5^{th} aspect of the present invention, wherein:
the play list file menu information on all or a part of said stored play list file menu is displayed to the outside,
said predetermined play list file is selected according to an instruction from the outside, and
the predetermined data stored by said plurality of data files respectively is reproduced by using said reproduction order based on said selected play list file.

The 7^{th} aspect of the present invention is a reproducing apparatus comprising:
play list file menu display means of displaying to the outside play list file menu information on all or a part of a play list file menu which is information of selecting a predetermined play list file of a plurality of play list files of storing a play list describing reproduction order of a plurality of data files of storing predetermined data, said play list file menu stored in a play list file menu file held on a record medium holding said plurality of data files and also holding said plurality of play list files;
play list file selecting means of selecting said predetermined play list file according to an instruction from the outside; and
data reproducing means of reproducing the predetermined data stored by said plurality of data files respectively by using said reproduction order based on said selected play list file.

The 8^{th} aspect of the present invention is a record medium holding a plurality of data files of storing predetermined data and also holding a plurality of play list files of storing a play list describing reproduction order of said plurality of data files, and
further holding a play list file menu file of storing a play list file menu which is information of selecting a predetermined play list file of said plurality of play list files.

The 9^{th} aspect of the present invention is the record medium according to the 8^{th} aspect of the present invention, wherein:
the play list file menu information on all or a part of said stored play list file menu is displayed to the outside,
said predetermined play list file is selected according to an instruction from the outside, and
the predetermined data stored by said plurality of data files respectively is reproduced by using said reproduction order based on said selected play list file.

The 10^{th} aspect of the present invention is a recording and reproducing method comprising:
a play list file menu storing step of storing a play list file menu which is information of selecting a predetermined play list file of a plurality of play list files of storing a play list describing reproduction order of a plurality of data files of storing predetermined data in a play list file menu file held on a record medium holding said plurality of data files and also holding said plurality of play list files;
a play list file menu display step of displaying to the outside play list file menu information on all or a part of said stored play list file menu;
a play list file selecting step of selecting said predetermined play list file according to an instruction from the outside; and
a data reproducing step of reproducing the predetermined data stored by said plurality of data files respectively by using said reproduction order based on said selected play list file.

The 11^{th} aspect of the present invention is a recording method comprising a play list file menu storing step of storing a play list file menu which is information of selecting a predetermined play list file of a plurality of play list files of storing a play list describing reproduction order of a plurality of data files of storing predetermined data in a play list file menu file held on a record medium holding said plurality of data files and also holding said plurality of play list files.

The 12^{th} aspect of the present invention is a reproducing method comprising:
a play list file menu display step of displaying to the outside play list file menu information on all or a part of a play list file menu which is information of selecting a predetermined play list file of a plurality of play list files of storing a play list describing reproduction order of a plurality of data files of storing predetermined data, said play list file menu stored in a play list file menu file held on a record medium holding said plurality of data files and also holding said plurality of play list files;
a play list file selecting step of selecting said predetermined play list file according to an instruction from the outside; and
a data reproducing step of reproducing the predetermined data stored by said plurality of data files respectively by using said reproduction order based on said selected play list file.

The 13^{th} aspect of the present invention is a program of, per recording and reproducing method according to the 10^{th} aspect of the present invention, causing a computer to execute:
the play list file menu storing step of storing a play list file menu which is information of selecting a predetermined play list file of a plurality of play list files of storing a play list describing reproduction order of a plurality of data files of storing predetermined data in a play list file menu file held on a record medium holding said plurality of data files and also holding said plurality of play list files;
the play list file menu display step of displaying to the outside play list file menu information on all or a part of said stored play list file menu;
the play list file selecting step of selecting said predetermined play list file according to an instruction from the outside; and
the data reproducing step of reproducing the predetermined data stored by said plurality of data files respectively by using said reproduction order based on said selected play list file.

The 14^{th} aspect of the present invention is a program of, per recording method according to the 11^{th} aspect of the present invention, causing a computer to execute the play list file menu storing step of storing a play list file menu which is information of selecting a predetermined play list file of a plurality of play list files of storing a play list describing reproduction order of a plurality of data files of storing predetermined data in a play list file menu file held on a record medium holding said plurality of data files and also holding said plurality of play list files.

The 15^{th} aspect of the present invention is a program of, per reproducing method according to the 12^{th} aspect of the present invention, causing a computer to execute:
the play list file menu display step of displaying to the outside play list file menu information on all or a part of a play list file menu which is information of selecting a predetermined play list file of a plurality of play list files of storing a play list describing reproduction order of a plurality of data files of storing predetermined data, said play list file menu stored in a play list file menu file held on a record medium holding said plurality of data files and also holding said plurality of play list files;
the play list file selecting step of selecting said predetermined play list file according to an instruction from the outside; and
the data reproducing step of reproducing the predetermined data stored by said plurality of data files respectively by using said reproduction order based on said selected play list file.

The 16^{th} aspect of the present invention is a record medium processable by a computer and supporting the program according to the 13^{th} aspect of the present invention.

The 17^{th} aspect of the present invention is a record medium processable by a computer and supporting the program according to the 14^{th} aspect of the present invention.

The 18^{th} aspect of the present invention is a record medium processable by a computer and supporting the program according to the 15^{th} aspect of the present invention.

### BRIEF DESCRIPTION OF THE DRAWINGS

[FIG. 1]

FIG. 1 is a block diagram of a recording and reproducing system according to a first embodiment of the present invention.

[FIG. 2]

FIG. 2 is an explanatory diagram of a data storage format of a play list file group 17 according to the first embodiment of the present invention.

[FIG. 3]

FIG. 3 is an explanatory diagram of the data storage format of a menu definition file 16 according to the first embodiment of the present invention.

[FIG. 4]

FIG. 4 is an explanatory diagram of a display screen (1) according to the first embodiment of the present invention.

[FIG. 5]

FIG. 5 is an explanatory diagram of a display screen (2) according to the first embodiment of the present invention.

[FIG. 6]

FIG. 6 is an explanatory diagram of a display screen (3) according to the first embodiment of the present invention.

[FIG. 7]

FIG. 7 is an explanatory diagram of a display screen (4) according to the first embodiment of the present invention.

### DESCRIPTION OF REFERENCE NUMERALS

10 Recording apparatus
11 Write file management means
12 Internal storage means
13 Data file group
14 File recording means
15 CD-RW medium
16 Menu definition file
17 Play list file group
20 Reproducing apparatus
21 Controlling means
22 Reproduction instructing means (remote control)
23 File reproducing means
24 Data file output means
31 Write file selecting means
32 Play list file creating means
33 Menu definition file creating means

### PREFERRED EMBODIMENTS OF THE INVENTION

Hereafter, embodiments of the present invention will be described by referring to the drawings.

### First Embodiment

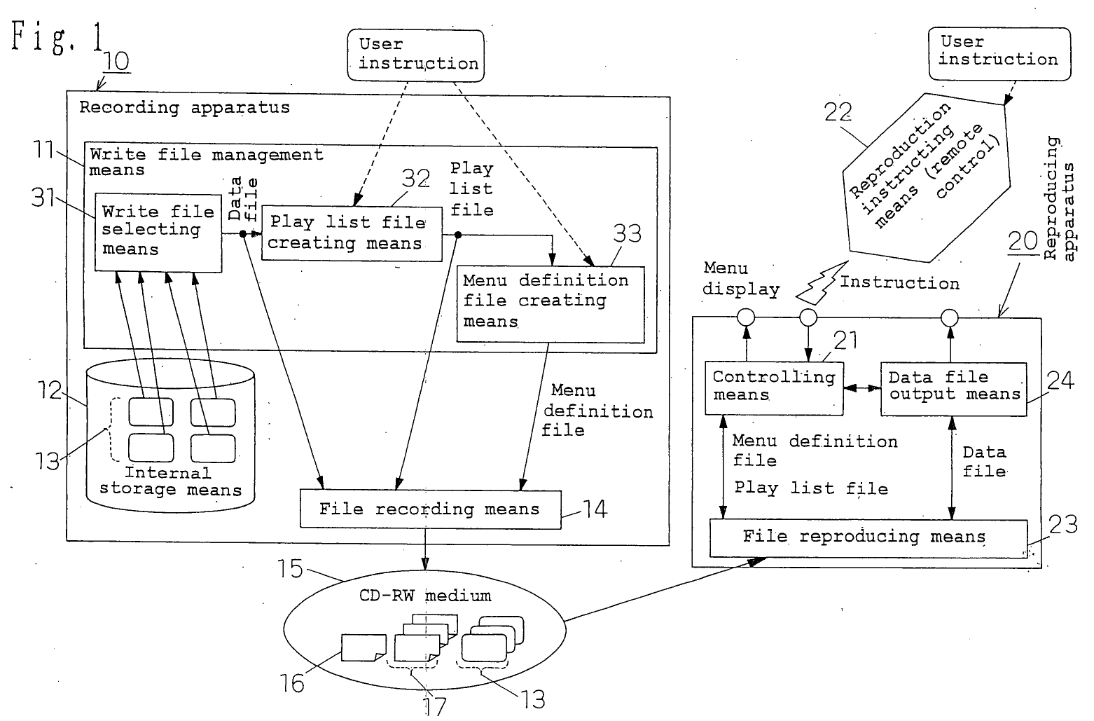

To begin with, configuration of a recording and reproducing system according to a first embodiment of the present invention will be described by referring to FIG. 1 which is a block diagram thereof.

A recording apparatus 10 has (1) write file management means 11 having write file selecting means 31, play list file creating means 32 and menu definition file creating means 33, (2) internal storage means 12 of storing a data file group 13, and (3) file recording means 14 of recording on a CD-RW (Compact Disk Rewritable) medium 15 storing the data file group 13, a menu definition file 16 and a play list file group 17.

To be more specific, the write file management means 11 has a CPU (Central Processing Unit) and so on. In addition, the internal storage means 12 has an HD (Hard Disk) and so on. In addition, the file recording means 14 has a CD-RW drive and so on.

The menu definition file 16 and play list file group 17 will be described in detail later.

A reproducing apparatus 20 has (1) controlling means 21 of inputting an instruction provided by reproduction instructing means (remote control) 22 and exerting control, (2) file reproducing means 23 of performing reproduction from the CD-RW medium 15, and (3) data file output means 24.

To be more specific, the controlling means 21 has a CPU and so on. In addition, the file reproducing means 23 has a CD-RW drive and so on. In addition, the data file output means 24 has a decoder and so on.

In this embodiment, the reproducing apparatus 20 only supports an audio file, and a menu and so on will be displayed considering that the data type reproducible by the data file output means 24 is only audio as will be mentioned in detail later.

Here, the menu definition file 16 and play list file group 17 will be described in detail.

First, (A) the play list file group 17 and then (B) the menu definition file 16 will be described.

(A) The play list file group 17 is a file group having play list files (that is, play list files #1, #2, #3 . . . ) describing a reproduction specification order of all or a part of the data files of the data file group 13 by using identification information of the data files. As a matter of course, the play list file may specify the same data file more than once in one reproduction specification order.

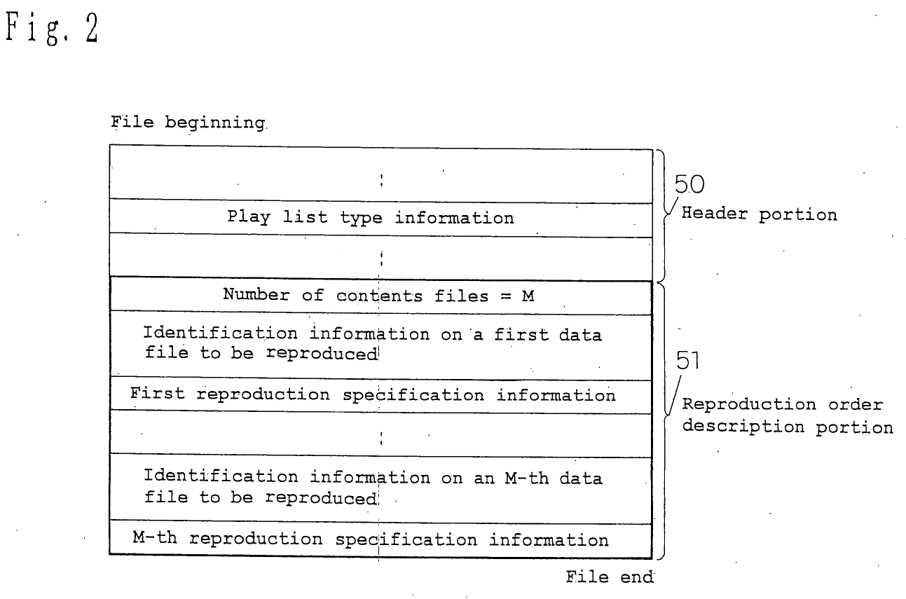

Here, the play list file will be described further in detail by referring to FIG. 2 which is an explanatory diagram of the data storage format of the play list file belonging to the play list file group 17 according to the first embodiment of the present invention.

The play list file is comprised of a header portion 50 and a reproduction order description portion 51.

The header portion 50 stores play list type information for indicating which of the audio, video and static image a data file type included in the play list file is.

In this embodiment, for instance, the play list files of which play list type information is audio are the play list files #1, #2 and #3.

The reproduction order description portion 51 stores the number M of the data files of the data file group 13 specifying the reproduction order as the number of contents files, and also stores the identification information for identifying the M pieces of data file in the reproduction specification order. In addition, in the case where a reproduction method is specified, the reproduction order description portion 51 has the specification of the reproduction method stored therein as reproduction specification information. The reproduction specification information is the information for specifying a reproduction starting position, a reproduction ending position and so on as to the audio file or video file, and it is the information for specifying display duration of the static image and so on as to the static image file.

(B) The menu definition file 16 is a file for defining the menu used for selecting the play list file by utilizing hierarchization of the play list files. As a matter of course, the hierarchization has substantial meaning in the case where a plurality of play list files exist.

In this embodiment, for instance, the first menu portion having the play list file #1 is a parent menu which is the highest-order menu of the hierarchical menus, and an N-th menu portion having the play list files #2, #3 is a child menu thereof.

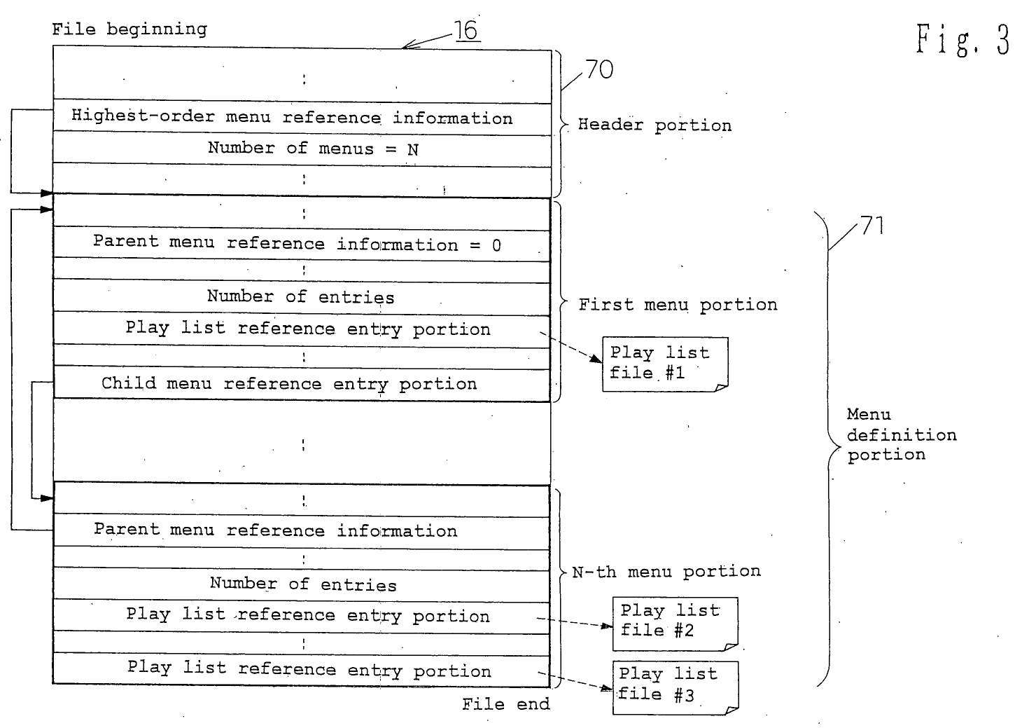

Here, the menu definition file 16 will be described further in detail by referring to FIG. 3 which is an explanatory diagram of the data storage format of the menu definition file 16 according to the first embodiment of the present invention.

The menu definition file 16 is comprised of a header portion 70 and a menu definition portion 71.

The header portion 70 stores highest-order menu reference information and the number of menus.

The highest-order menu information stores a storage position in the menu definition file 16 of the information defining the highest-order menu contents of the hierarchical menus.

The number of menus stores the number N of menu portions stored in the menu definition portion 71.

The menu definition portion 71 stores first to N-th menu portions.

The first to N-th menu portions are corresponding to sections when representing the hierarchical menus as a tree structure, and store parent menu reference information, number of entries, a play list reference entry portion and a child menu reference entry portion.

The parent menu reference information stores the storage position in the menu definition file 16 of the menu portion equivalent to a parent when representing the hierarchical menus as the tree structure. In addition, the parent menu reference information stores static image file identification information to be associated with a thumbnail static image file (not shown) having a predetermined number of pixels recorded on the CD-RW medium 15. In addition, the parent menu reference information stores text file identification information to be associated with a text file (not shown) on the contents of the parent menu recorded on the CD-RW medium 15.

The number of entries stores the number of entry portions stored in the menu portions respectively.

The play list reference entry portion stores a unique play list file ID provided to each of the play list files as the information for identifying the play list files. In addition, the play list reference entry portion stores the static image file identification information to be associated with a thumbnail static image file (not shown) just as the parent menu reference information does. In addition, the play list reference entry portion stores the text file identification information to be associated with a text file (not shown) on the contents of the play lists just as the parent menu reference information does.

The child menu reference entry portion stores the storage position in the menu definition file 16 of the menu portion equivalent to a child when representing the hierarchical menus as the tree structure. In addition, the child menu reference entry portion stores the static image file identification information to be associated with a thumbnail static image file (not shown) just as the parent menu reference information does. In addition, the child menu reference entry portion stores the text file identification information to be associated with a text file (not shown) on the contents of the child menu as the parent menu reference information does. In addition, the child menu reference entry portion stores as menu type information the information which is collective play list type information on the play list files selectable through the menus of layers of and below the child menu in addition to the storage position of the child menu.

In this embodiment, the play lists selectable through the menus of lower layers are only the play list files #1, #2 and #3 of which play list type information is audio, and the menu type information is audio. As will be described later, it is possible to read the menu type information and display no child menu of a type not supported by the reproducing apparatus so as not to be selected by a user, and so usability is improved with no non-reproducibility error occurring due to selection of an irreproducible play list.

The configuration of the recording and reproducing system according to this embodiment was described in detail above.

Next, the operation of the recording and reproducing system according to this embodiment will be described.

Moreover, an embodiment of a recording and reproducing method, a recording method and a reproducing method of the present invention will also be described while describing the operation of the recording and reproducing system according to this embodiment.

\mathring{1} First, a description will be given as to the operation of the recording apparatus 10 of recording the data file of the data file group 13, the play list files #1, #2, #3 . . . and the menu definition file 16 on the CD-RW medium 15.

The write file selecting means 31 follows an instruction provided by a user to the effect that “the play list files #1, #2, #3 . . . and the menu definition file 16 should be created, and the data file of the data file group 13, the created play list files #1, #2 and #3 and the created menu definition file 16 should be recorded on the CD-RW medium 15, ” and selects the data file of the data file group 13 to be recorded on the CD-RW medium 15, of the data files of the data file group 13 stored in the internal storage means 12.

The play list file creating means 32 creates the play list files #1, #2, #3 . . . describing the reproduction specification order for the data file of the data file group 13 selected by the write file selecting means 31 according to a user instruction by means of GUI (Graphical User Interface) input.

As previously mentioned, the reproduction specification order for all or a part of the data files of the data file group 13 is described by using the identification information of the data files (refer to FIG. 2).

The menu definition file creating means 33 creates the menu definition file 16 for defining the menu used for selecting the play list files #1, #2, #3 . . . created by the play list file creating means 32 according to the user instruction by means of the GUI input.

As previously mentioned, the menu used for selecting the play list files #1, #2, #3 . . . is defined by utilizing the hierachization of the play list files #1, #2, #3 . . . (refer to FIG. 3).

The file recording means 14 records the data file of the data file group 13 selected by the write file selecting means 31 on the CD-RW medium 15, and also records the play list files #1, #2, #3 . . . created by the play list file creating means 32 and the menu definition file 16 created by the menu definition file creating means 33 on the CD-RW medium 15.

As a matter of course, the play list files #1, #2 and #3, . . . thus recorded on the CD-RW medium 15 may be updated or deleted.

And the menu definition file 16 thus recorded on the CD-RW medium 15 may have the play list files updated, deleted or added.

\mathring{2} Next, the operation of the reproducing apparatus 20 of reproducing the data file recorded on the CD-RW medium 15 will be described.

The reproduction instructing means 22 follows an instruction provided by the user to the effect that “the file recorded on the CD-RW medium 15 should be reproduced, ” and instructs the controlling means 21 likewise.

The controlling means 21 follows the instruction provided by the reproduction instructing means 22, and instructs the file reproducing means 23 to read the contents of the menu definition file 16 recorded on the CD-RW medium 15.

The file reproducing means 23 follows the instruction provided by the controlling means 21, and reads the contents of the menu definition file 16 recorded on the CD-RW medium 15.

The controlling means 21 interprets the contents of the menu definition file 16 which was read, and instructs the file reproducing means 23 to read the thumbnail static image file required for displaying a first menu screen of the aforementioned thumbnail static image files (not shown).

The file reproducing means 23 follows the instruction provided by the controlling means 21, and reads the thumbnail static image file required for displaying the first menu screen recorded on the CD-RW medium 15.

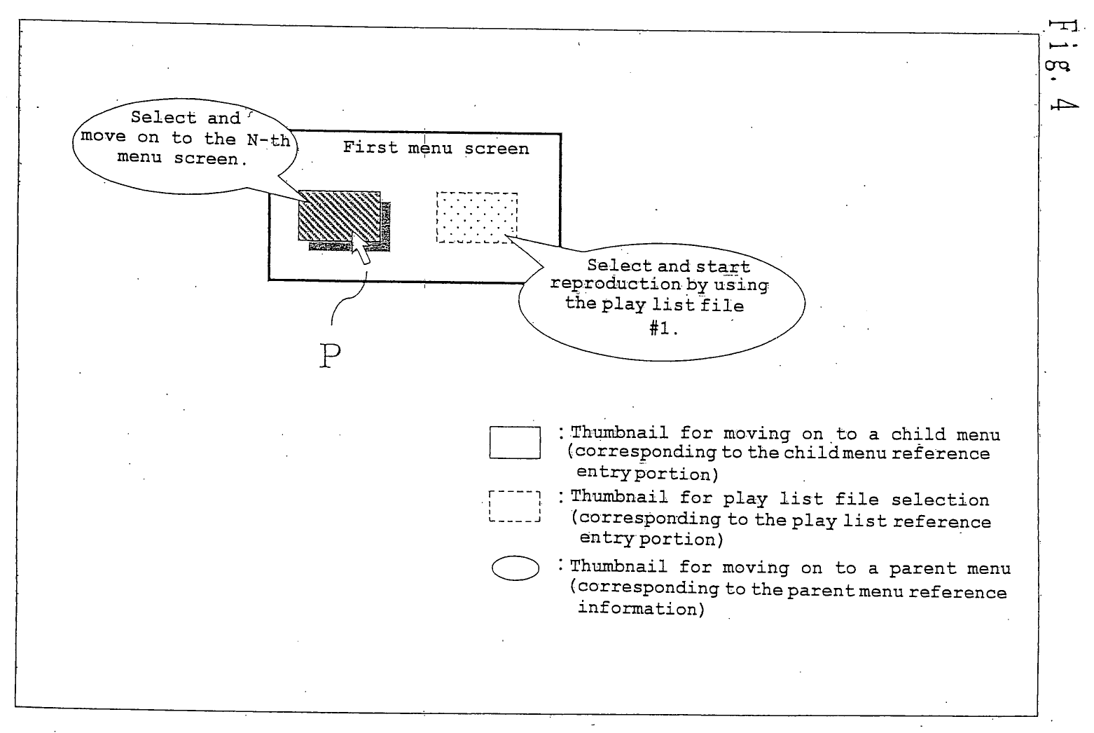

The controlling means 21 interprets the thumbnail static image file which was read, and outputs to the user by using a display device (not shown) the display screen as shown in FIG. 4 which is an explanatory diagram of a display screen (1) according to the first embodiment of the present invention.

In the lower right portion of the display screen (1), there is a description displayed to the effect that a rectangular button indicated by solid lines is the thumbnail static image for the sake of moving on to the child menu corresponding to the child menu reference entry portion, a rectangular button indicated by dotted lines is the thumbnail static image for the sake of selecting the play list file corresponding to the play list reference entry portion, and an oval button is the thumbnail static image for the sake of making a transition to the parent menu corresponding to the parent menu reference information.

In addition, the rectangular button indicated by the solid lines and the rectangular button indicated by the dotted lines have help messages “Select and move on to the N-th menu screen” and “Select and start reproduction by using the play list file #1” displayed thereto respectively.

As all of the information on the play list files and the static image file identification information on the thumbnail static image files is written to the menu definition file 16, such operation is performed at high speed without an analysis of a file system and file access to individual files.

\mathring{3} Next, a description will be given as to the operation of the reproducing apparatus 20 of selecting the play list file to be used when performing the reproduction by using the menu definition file 16 recorded on the CD-RW medium 15.

The reproduction instructing means 22 follows an instruction provided by the user having seen the display screen by means of a double-click on the rectangular button indicated by the solid lines with a pointer P, and instructs the controlling means 21 to “move on to the N-th menu screen.”

Moreover, if double-click is performed with the pointer P, the thumbnail static image of the rectangular button indicated by the solid lines changes from a state of non-selection to a state of selection accompanied by a drop shadow.

The controlling means 21 follows the instruction provided by the reproduction instructing means 22, and interprets the contents of the menu definition file 16 which has already been read, and instructs the file reproducing means 23 to read the thumbnail static image file required for displaying the N-th menu screen of the aforementioned thumbnail static image files (not shown).

The file reproducing means 23 follows the instruction provided by the controlling means 21, and reads the thumbnail static image file required for displaying the N-th menu screen recorded on the CD-RW medium 15.

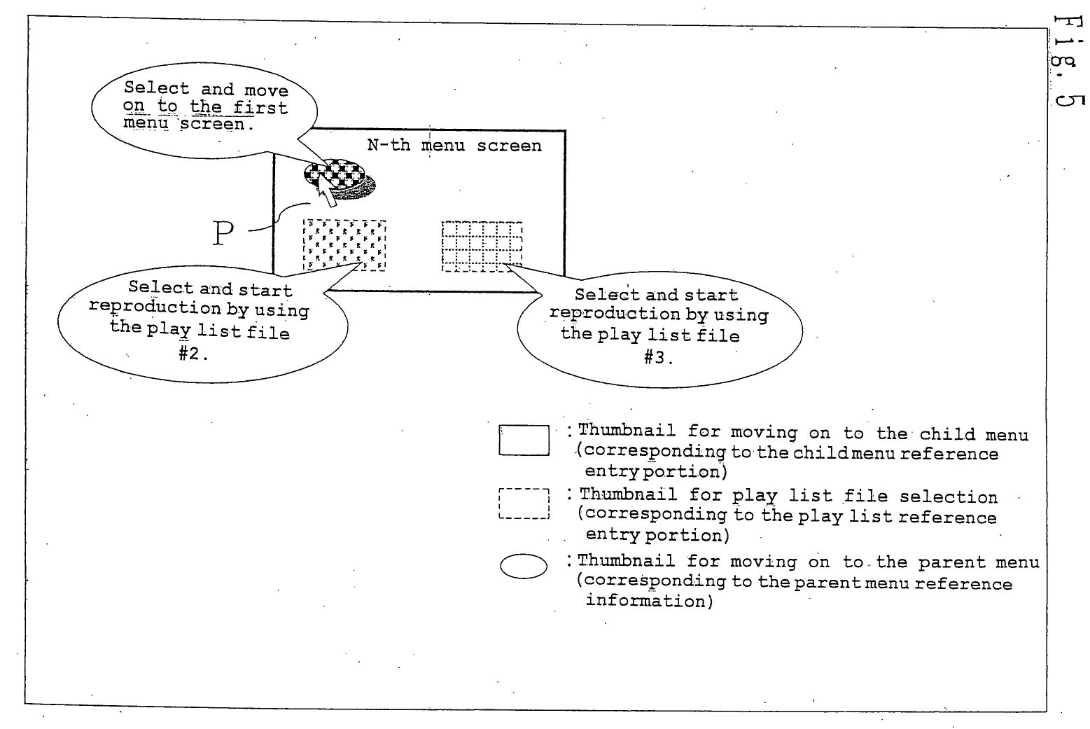

The controlling means 21 interprets the thumbnail static image file which was read, and outputs to the user by using the display device (not shown) the display screen as shown in FIG. 5 which is an explanatory diagram of a display screen (2) according to the first embodiment of the present invention.

The same description as in the aforementioned display screen (1) is displayed in the lower right portion of the display screen (2).

In addition, the rectangular button indicated by the dotted lines on the left, the rectangular button indicated by the dotted lines on the right and oval button have the help messages “Select and start reproduction by using the play list file #2,” “Select and start reproduction by using the play list file #3” and “Select and move on to the first menu screen” displayed thereto respectively.

The reproduction instructing means 22 follows an instruction provided by the user having seen the display screen by means of a double-click on the oval button with the pointer P, and instructs the controlling means 21 to “move on to the first menu screen.”

Moreover, if double-click is performed with the pointer P, the thumbnail static image of the oval button changes from the state of non-selection to the state of selection accompanied by the drop shadow.

The controlling means 21 follows the instruction provided by the reproduction instructing means 22, and interprets the contents of the menu definition file 16 which has already been read, and instructs the file reproducing means 23 to read the thumbnail static image file required for displaying the first menu screen of the aforementioned thumbnail static image files (not shown).

The file reproducing means 23 follows the instruction provided by the controlling means 21, and reads the thumbnail static image file required for displaying the first menu screen recorded on the CD-RW medium 15.

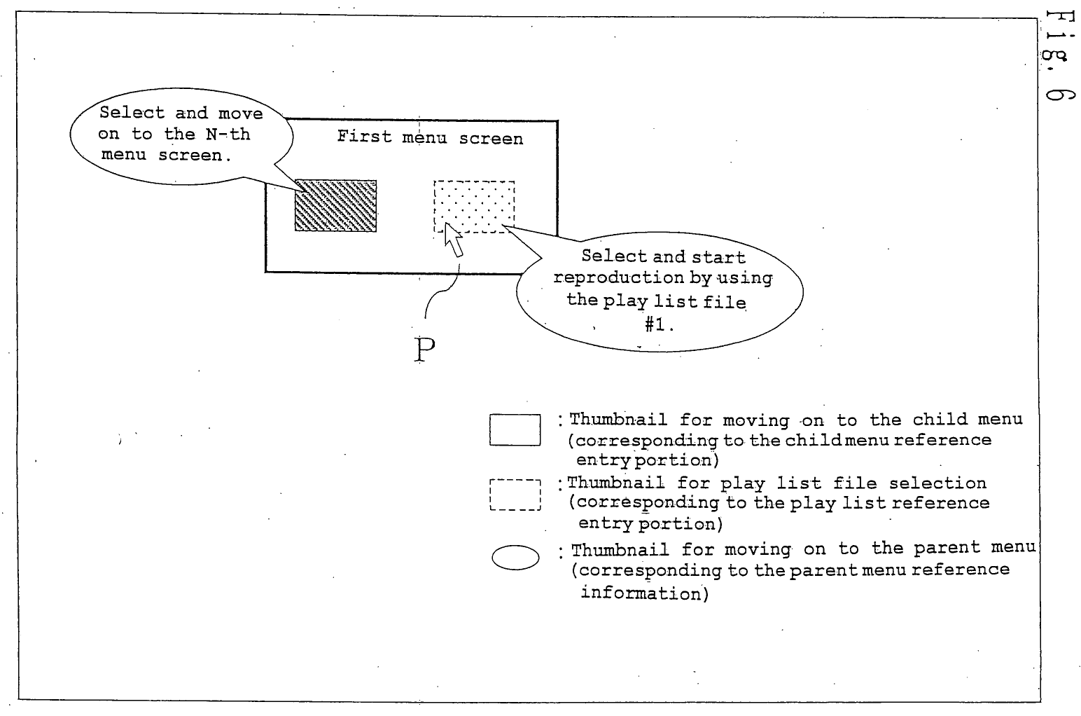

The controlling means 21 interprets the thumbnail static image file which was read, and outputs to the user by using the display device (not shown) the display screen as shown in FIG. 6 which is an explanatory diagram of a display screen (3) according to the first embodiment of the present invention.

The same description as in the aforementioned display screen (1) is displayed in the lower right portion of the display screen (3).

In addition, the rectangular button indicated by the solid lines and the rectangular button indicated by the dotted lines have the same help messages as in the aforementioned display screen (1) displayed thereto respectively.

As previously mentioned, all of the information on the play list files and the static image file identification information on the thumbnail static image files is written to the menu definition file 16, and so such operation is performed at high speed without the analysis of the file system and file access to the individual files.

\mathring{4} Next, a description will be given as to the operation of the reproducing apparatus 20 of seeing the contents of the play list file #1 by using the menu definition file 16 recorded on the CD-RW medium 15.

The reproduction instructing means 22 follows the instruction provided by the user having seen the display screen by means of a right click on the rectangular button indicated by the solid lines with the pointer P, and instructs the controlling means 21 to “see the contents of the play list file #1.”

The controlling means 21 follows the instruction provided by the reproduction instructing means 22, and interprets the contents of the menu definition file 16 which has already been read, and instructs the file reproducing means 23 to read the text file required for displaying the contents of the play list file #1 of the aforementioned text files (not shown)

The file reproducing means 23 follows the instruction provided by the controlling means 21, and reads the text file required for displaying the contents of the play list file #1 recorded on the CD-RW medium 15.

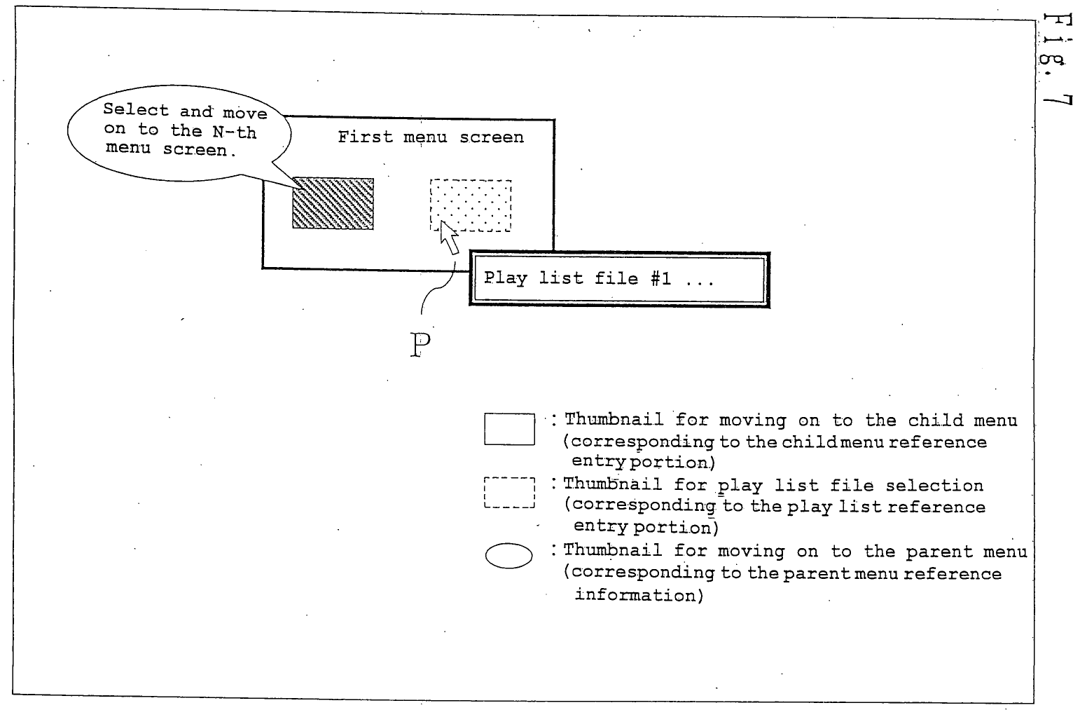

The controlling means 21 interprets the text file which was read, and outputs to the user by using the display device (not shown) the display screen as shown in FIG. 7 which is an explanatory diagram of a display screen (4) according to the first embodiment of the present invention.

The display screen (4) has a description of the contents of the play list file #1 “The play list file #1 is . . . ” pop-up displayed thereon instead of the help message “Select and start reproduction by using the play list file #1.”

As the information on the play list files and text file identification information on the text files is written to the menu definition file 16, such operation is performed at high speed without the analysis of the file system and file access to the individual files.

\mathring{5} Next, a description will be given as to the operation of the reproducing apparatus 20 of reproducing the files recorded on the CD-RW medium 15.

The reproduction instructing means 22 follows an instruction provided by the user having seen the display screen by means of a double-click on the rectangular button indicated by the dotted lines with the pointer P, and instructs the controlling means 21 to “start the reproduction by using the play list file #1.”

The controlling means 21 follows the instruction provided by the reproduction instructing means 22, and instructs the file reproducing means 23 likewise.

The file reproducing means 23 follows the instruction provided by the controlling means 21, and reads the contents of the play list file #1 recorded on the CD-RW medium 15.

The controlling means 21 interprets the contents of the play list file #1 which was read, and instructs the file reproducing means 23 to reproduce the file recorded on the CD-RW medium 15 by using the play list file #1.

The file reproducing means 23 follows the instruction provided by the controlling means 21, and reads the contents of the data files recorded on the CD-RW medium 15.

The data file output means 24 outputs the contents of the data files which were read by utilizing format conversion from a file format to an output format.

As a matter of course, such reading of the contents of the data files and output of the contents of the read data files are performed in the reproduction order of the data files described in the play list file #1.

The operation of the recording and reproducing system according to this embodiment was described in detail above.

Next, effects that the recording and reproducing system according to this embodiment has will be described.

The recording and reproducing system according to this embodiment easily realizes a function of selecting the play list file, when reproducing the data file, just by reading a menu definition file having a plurality of play list files created in advance hierarchically described therein without analyzing a directory structure.

For this reason, the recording and reproducing system according to this embodiment can reproduce the data file in the reproduction order just as intended by a creator of the record medium due to a device configuration which is inexpensive and user-friendly.

The first embodiment was described in detail above.

(1) Moreover, according to the above-mentioned embodiment, the play list files of the present invention are the play list files #1, #2, #3 . . . belonging to the play list file group 17.

However, the play list files of the present invention are not limited thereto, but in short, they may be any files for describing the reproduction order of the plurality of data files for storing predetermined data.

(2) In addition, according to the above-mentioned embodiment, the play list file menu file of the present invention is the menu definition file 16.

However, the play list file menu file of the present invention is not limited thereto, but in short, it may be any file to be held by the record medium for the sake of storing the play list file menu which is the information for selecting a predetermined play list file of the plurality of play list files.

(3) In addition, according to the above-mentioned embodiment, the record medium of the present invention is the CD-RW medium 15.

However, the record medium of the present invention is not limited thereto, but it may be a removable medium such as a CD-R (Compact Disk-Recordable) medium or a DVD-R (Digital Versatile Disk-Recordable) medium or a built-in storage such as an HDD (Hard Disk Drive) built into the recording apparatus or reproducing apparatus.

In short, the record medium of the present invention may be any record medium holding the plurality of data files for storing the predetermined data and also holding the plurality of play list files for storing the play lists describing the reproduction order of the plurality of data files, which is the means of further holding the play list file menu file for storing the play list file menu as the information for selecting a predetermined play list file of the plurality of play list files.

(4) In addition, according to the above-mentioned embodiment, play list file menu storing means of the present invention is the means including the file recording means 14 and menu definition file creating means 33.

However, the play list file menu storing means of the present invention is not limited thereto, but in short, it may be any means of storing in the play list file menu file held by the record medium the play list file menu which is the information for selecting the predetermined play list file of the plurality of play list files.

(5) In addition, according to the above-mentioned embodiment, play list file menu display means of the present invention is the means including the controlling means 21, file reproducing means 23 and data file output means 24.

However, the play list file menu display means of the present invention is not limited thereto, but in short, it may be any means of displaying to the outside the play list file menu information on all or a part of the stored play list file menus.

(6) In addition, according to the above-mentioned embodiment, play list file selecting means of the present invention is the means including the controlling means 21, reproduction instructing means 22, file reproducing means 23 and data file output means 24.

However, the play list file selecting means of the present invention is not limited thereto, but in short, it may be any means of selecting the predetermined play list file according to an instruction from the outside.

(7) In addition, according to the above-mentioned embodiment, data reproducing means of the present invention is the means including the controlling means 21, file reproducing means 23 and data file output means 24.

However, the data reproducing means of the present invention is not limited thereto, but in short, it may be any means of reproducing the predetermined data stored in the plurality of data files respectively by using the reproduction order based on a selected play list file.

(8) In addition, according to the above-mentioned embodiment, the play list file menu display means of the present invention performs display by using the change of the state of the thumbnail static image from the state of non-selection to the state of selection accompanied by the drop shadow.

However, the play list file menu display means of the present invention is not limited thereto, but it may also perform the display by using two totally different types of thumbnail static image files for the state of non-selection and the state of selection.

In short, the play list file menu display means of the present invention may display the play list file menu information by using the thumbnail image which changes according to the state in which the play list file selecting means selects the predetermined play list file.

(9) In addition, according to the above-mentioned embodiment, the play list file menu display means of the present invention displays the description of the contents of the play list file by using the text file identification information to be associated with the text file stored in the menu definition file 16.

However, the play list file menu display means of the present invention is not limited thereto, but it may also display the description of the contents of the play list file by further using the text display data file identification information to be associated with the text display data file on text character colors and/or text background images stored in the menu definition file 16.

In short, the play list file menu display means of the present invention may display the play list file menu information by using the predetermined text data on all or a part of the play lists.

Moreover, the program of the present invention is the program for causing the computer to execute the functions of all or a part of the means (or apparatuses, elements and so on) of the above-mentioned recording and reproducing system, recording apparatus and reproducing apparatus of the present invention, the program operating in cooperation with the computer.

In addition, the program of the present invention is the program for causing the computer to execute the operations of all or a part of the steps (or processes, workings, actions and so on) of the above-mentioned recording and reproducing method, recording method and reproducing method of the present invention, the program operating in cooperation with the computer.

In addition, the record medium of the present invention is the record medium supporting the program for causing the computer to execute all or a part of the functions of all or a part of the means (or apparatuses, elements and so on) of the above-mentioned recording and reproducing system, recording apparatus and reproducing apparatus of the present invention, the record medium being readable by the computer and having the above described functions performed by the above described program which is read in cooperation with the above described computer.

In addition, the record medium of the present invention is the record medium supporting the program for causing the computer to execute all or a part of the operations of all or a part of the steps (or processes, workings, actions and soon) of the above-mentioned recording and reproducing method, recording method and reproducing method of the present invention, the record medium being readable by the computer and having the above described operations performed by the above described program which is read in cooperation with the above described computer.

In addition, the record medium of the present invention is the record medium supporting a data structure utilized in cooperation with the computer in all or a part of the means (or apparatuses, elements and so on) and the steps (or processes, workings, actions and so on) of the above-mentioned recording and reproducing system, recording apparatus, reproducing apparatus, recording and reproducing method, recording method and reproducing method of the present invention, the record medium being readable by the computer and having the above described data structure which is read utilized in cooperation with the above described computer.

Moreover, the above “part of the means (or apparatuses, elements and so on)” of the present invention means one or a few of such a plurality of means, and the above “part of the steps (or processes, workings, actions and so on)” of the present invention means one or a few of such a plurality of steps.

In addition, the above “functions of the means (or apparatuses, elements and so on)” of the present invention means all or a part of the functions of the above described means, and the above “operations of the steps (or processes, workings, actions and so on)” of the present invention means all or a part of the operations of the above described steps.

In addition, a form using the program of the present invention maybe the form recorded on the record medium readable by the computer and operating in cooperation with the computer.

In addition, a form of using the program of the present invention maybe the form transmitted in a transmission medium and read by the computer to operate in cooperation with the computer.

In addition, the data structure of the present invention includes a database, a data format, a data table, a data list, a data type and so on.

In addition, the record media include an ROM and so on, and the transmission media include the transmission media such as the Internet, light, a radio wave, a sound wave and so on.

In addition, the above described computer of the present invention is not limited to pure hardware such as a CPU, but may include firmware, an OS and peripherals on top of them.

Moreover, as described above, the configuration of the present invention may be implemented either software-wise or hardware-wise.

As is clear from the above description, the present invention has an advantage that, even in the case where the plurality of play list files are stored in the record medium such as the CD-R, the play list files can be efficiently managed.

1. A recording and reproducing system comprising:
a record medium holding a plurality of data files of storing predetermined data and also holding a plurality of play list files of storing a play list describing reproduction order of said plurality of data files;
play list file menu storing means of storing a play list file menu which is information of selecting a predetermined play list file of said plurality of play list files in a play list file menu file held on said record medium;
play list file menu display means of displaying to the outside play list file menu information on all or a part of said stored play list file menu;
play list file selecting means of selecting said predetermined play list file according to an instruction from the outside; and
data reproducing means of reproducing the predetermined data stored by said plurality of data files respectively by using said reproduction order based on said selected play list file.

2. The recording and reproducing system according to claim 1, wherein said play list file menu display means displays said play list file menu information in consideration of a type of said predetermined data reproducible by said data reproducing means.

3. The recording and reproducing system according to claim 1, wherein said play list file menu display means displays said play list file menu information by using a thumbnail image changing according to a state in which said play list file selecting means selects said predetermined play list file.

4. The recording and reproducing system according to claim 1, wherein said play list file menu display means displays said play list file menu information by using predetermined text data on all or a part of said play list.

5. A recording apparatus comprising play list file menu storing means of storing a play list file menu which is information of selecting a predetermined play list file of a plurality of play list files of storing a play list describing reproduction order of a plurality of data files of storing predetermined data in a play list file menu file held by a record medium holding said plurality of data files and also holding said plurality of play list files.

6. The recording apparatus according to claim 5, wherein:
the play list file menu information on all or a part of said stored play list file menu is displayed to the outside,
said predetermined play list file is selected according to an instruction from the outside, and
the predetermined data stored by said plurality of data files respectively is reproduced by using said reproduction order based on said selected play list file.

7. A reproducing apparatus comprising:
play list file menu display means of displaying to the outside play list file menu information on all or a part of a play list file menu which is information of selecting a predetermined play list file of a plurality of play list files of storing a play list describing reproduction order of a plurality of data files of storing predetermined data, said play list file menu stored in a play list file menu file held on a record medium holding said plurality of data files and also holding said plurality of play list files;
play list file selecting means of selecting said predetermined play list file according to an instruction from the outside; and
data reproducing means of reproducing the predetermined data stored by said plurality of data files respectively by using said reproduction order based on said selected play list file.

8. A record medium holding a plurality of data files of storing predetermined data and also holding a plurality of play list files of storing a play list describing reproduction order of said plurality of data files, and
further holding a play list file menu file of storing a play list file menu which is information of selecting a predetermined play list file of said plurality of play list files.

9. The record medium according to claim 8, wherein:
the play list file menu information on all or a part of said stored play list file menu is displayed to the outside,
said predetermined play list file is selected according to an instruction from the outside, and
the predetermined data stored by said plurality of data files respectively is reproduced by using said reproduction order based on said selected play list file.

10. A recording and reproducing method comprising:
a play list file menu storing step of storing a play list file menu which is information of selecting a predetermined play list file of a plurality of play list files of storing a play list describing reproduction order of a plurality of data files of storing predetermined data in a play list file menu file held on a record medium holding said plurality of data files and also holding said plurality of play list files;
a play list file menu display step of displaying to the outside play list file menu information on all or a part of said stored play list file menu;
a play list file selecting step of selecting said predetermined play list file according to an instruction from the outside; and
a data reproducing step of reproducing the predetermined data stored by said plurality of data files respectively by using said reproduction order based on said selected play list file.

11. A recording method comprising a play list file menu storing step of storing a play list file menu which is information of selecting a predetermined play list file of a plurality of play list files of storing a play list describing reproduction order of a plurality of data files of storing predetermined data in a play list file menu file held on a record medium holding said plurality of data files and also holding said plurality of play list files.

12. A reproducing method comprising:
a play list file menu display step of displaying to the outside play list file menu information on all or a part of a play list file menu which is information of selecting a predetermined play list file of a plurality of play list files of storing a play list describing reproduction order of a plurality of data files of storing predetermined data, said play list file menu stored in a play list file menu file held on a record medium holding said plurality of data files and also holding said plurality of play list files;
a play list file selecting step of selecting said predetermined play list file according to an instruction from the outside; and
a data reproducing step of reproducing the predetermined data stored by said plurality of data files respectively by using said reproduction order based on said selected play list file.

13. A program of, per recording and reproducing method according to claim 10, causing a computer to execute:
the play list file menu storing step of storing a play list file menu which is information of selecting a predetermined play list file of a plurality of play list files of storing a play list describing reproduction order of a plurality of data files of storing predetermined data in a play list file menu file held on a record medium holding said plurality of data files and also holding said plurality of play list files;
the play list file menu display step of displaying to the outside play list file menu information on all or a part of said stored play list file menu;
the play list file selecting step of selecting said predetermined play list file according to an instruction from the outside; and
the data reproducing step of reproducing the predetermined data stored by said plurality of data files respectively by using said reproduction order based on said selected play list file.

14. A program of, per recording method according to claim 11, causing a computer to execute the play list file menu storing step of storing a play list file menu which is information of selecting a predetermined play list file of a plurality of play list files of storing a play list describing reproduction order of a plurality of data files of storing predetermined data in a play list file menu file held on a record medium holding said plurality of data files and also holding said plurality of play list files.

15. A program of, per reproducing method according to claim 12, causing a computer to execute:
the play list file menu display step of displaying to the outside play list file menu information on all or a part of a play list file menu which is information of selecting a predetermined play list file of a plurality of play list files of storing a play list describing reproduction order of a plurality of data files of storing predetermined data, said play list file menu stored in a play list file menu file held on a record medium holding said plurality of data files and also holding said plurality of play list files;
the play list file selecting step of selecting said predetermined play list file according to an instruction from the outside; and
the data reproducing step of reproducing the predetermined data stored by said plurality of data files respectively by using said reproduction order based on said selected play list file.

16. A record medium processable by a computer and supporting the program according to claim 13.

17. A record medium processable by a computer and supporting the program according to claim 14.

18. A record medium processable by a computer and supporting the program according to claim 15.
